(19) United States
(12) Patent Application Publication
(10) Pub. No.: US 2009/0166280 A1
(43) Pub. Date: Jul. 2, 2009

(54) WASTEWATER PURIFYING SYSTEM IN HOSPITALS

(75) Inventor: Yubo DONG, Beijing (CN)

Correspondence Address: YING CHEN;Chen Yoshimura LLP, 255 S. GRAND AVE., # 215, LOS ANGELES, CA, 90012, US

(73) Assignee: Beijing Jinaohuarong Science and Technology Co., Ltd., Beijing (CN)

(21) Appl. No.: 12/118,273

(22) Filed: May 9, 2008

(30) Foreign Application Priority Data
Dec. 28, 2007 (CN) 200710304546.6

(51) Int. Cl. B01D 21/24; B01D 15/00

(52) U.S. Cl. 210/202; 210/243

(57) ABSTRACT

This invention relates a wastewater purifying system in hospitals, comprising interconnected grilles, a regulating disinfection pool, a coagulation pool, a preliminary settling tank, a hydrolysis-acidification pool, an aerobic bio-filter, a secondary settling tank, an advanced oxidation device, a sludge pool and a recycling impounding reservoir. The regulating disinfection pool is used to accumulate original wastewater released from every source and the advanced oxidation device is used to oxidize remained organic matters into inorganic molecules via chemical and biochemical methods or via physical methods and could be an electric biological oxidation treatment device. This system possesses high purifying degree and purified water from this system can be used as reclaimed water.

### BACKGROUND OF THE INVENTION

1. Field of the Invention

This invention relates to a wastewater purifying system in hospital. The water purified by this system can be used as reclaimed water.

2. Description of the Related Art

The medical wastewater is mainly released from surgeries, labouratories, wards, washhouses, X-ray photo rooms and operating rooms with complicated sources and components. Wastewater in hospitals contains large amount of pathogenetic bacteria, virus and chemical agents with the characters of space pollution, acute infection and latent infection. As a kind of special wastewater, hospital wastewater is treated and disinfected thoroughly abroad regardless it concerns the patients or not. However, there is no wastewater treatment system in most domestic hospitals and hospital wastewater is treated the same as ordinary domestic sewage at most times, which will be directly released to natural water body or municipal pipe networks and will easily cause bacteria and virus spreading, esp. those released to natural water body. People in downstream, who use that water to wash up even drink directly, will catch digestive or gastrointestinal disease.

Wastewater produced by health-care institutions and excrements of persons with infectious diseases or suspected ones shall be strictly disinfected under national regulations and be released into wastewater treatment system after reaching defined standards. This means there are disadvantages of discharging without treatment or without sufficient treatment in the wastewater treatment of our hospital system, which shall be treated thoroughly. Some experts believe that there are various bacteria and virus in medical wastewater with high infectivity and improper treatment or disposition will cause serious environmental pollution, endanger human health and make hospital a place “curing patients at the front gate while releasing poison at the back door”. Special treatment shall be applied strictly and wastewater treatment system shall be transformed with high and new technology to return people a safe environment.

At present, there are mainly two kinds of wastewater treatment technologies in hospitals: one is chlorination, adopting liquefied chlorine gas, sodium hypochlorite, chlorine dioxide, ozone and etc, mostly sodium hypochlorite; the other one is biological treatment, mainly adopting aerobic biological treatment or together with hydrolysis-acidification treatment under anaerobic condition as well as anaerobic biological treatment. Aerobic treatment is employed by most treatment systems because of its high purifying degree and low pollutant content while anaerobic biological treatment and hydrolysis-acidification treatment are better to turn large organic molecules, which are hard to be oxygenated, into small ones and to reduce sludge output, thus they are adopted by large treatment systems and compose batch treatment systems together with aerobic biological treatment. The choices of those treatment techniques and their compound modes have their characters and will provide their advantages and adoptions at different locations. However, on balance, it must be said that it is a great disadvantage of the present hospitals of lower wastewater treatment level, lower outlet purifying degree and no recycling today when emphasizing sustainable development.

### SUMMARY OF THE INVENTION

To overcome above deficiencies of present technical, this invention offers a wastewater purifying system in hospitals. The water purified by this system can be used as reclaimed water because of its high purifying degree and no infectivity.

The technical solution to realize above purposes is: a wastewater purifying system in hospitals, comprising:

one or more grilles, used to remove solid inclusions such as gauze, tampon, wherein its outlet connects with a inlet of a regulating disinfection pool;

a regulating disinfection pool, used to accumulate original wastewater released from every source, disinfect the original wastewater via chlorination to eliminate organisms especially causative organisms, regulate flow rate of subsequent components, wherein its outlet connects with a inlet of coagulation pool;

a coagulation pool, used to mix flocculants and flocculant aids to turn the suspended substances in the wastewater and part of organic matter into flocs, wherein its outlet connects with a inlet of a preliminary settling tank;

a preliminary settling tank, used to settle settleable matters in wastewater;

a hydrolysis-acidification pool, used to carry out biodegradation under anaerobic condition, turn large molecules into small molecules, wherein its outlet connects with a inlet of aerobic bio-filter;

an aerobic bio-filter, used to turn polluted organic molecules to pollution-free inorganic molecules via biological agent in the presence of oxygen, wherein its outlet connects with a inlet of secondary settling tank;

a secondary settling tank, used to settle settleable matters generated in the aerobic bio-filter as well as the original ones and its outlet connects with the inlet of advanced oxidation device;

an advanced oxidation device, used to oxidate remained organic matters into inorganic molecules via chemical and biochemical methods or via physical methods, wherein its outlet connects with a inlet of recycling impounding reservoir, wherein its bottom connected with a settling tank via pump;

a sludge pool, used to collect and primarily process the sludge from preliminary settling tank, secondary settling tank and advanced oxidation device;

a recycling impounding reservoir, used to collect purified water from previous components.

Because disinfection is performed in regulating pool, spoilage and causative organisms in original wastewater can be destroyed as soon as possible to avoid those organisms spreading pollution as well as reduce disease transmitting; because coagulation and settlement are carried out before biological treatment, the pollutants in wastewater are greatly reduced, which reduces the pollutant load of later devices and improves treatment effects; because the preliminary settling tank is place behind coagulation meanwhile coagulation and settlement are separated, the flocculating effect and settlement effect are favorable to be improved; because the hydrolysis-acidification pool is placed before the aerobic bio-filter, the biological properties and purifying effect are favorable to be improved; because bio-filter is used for aerobic biological treatment, the treatment effect is favorable to be improved; because there is advanced oxidation device behind aerobic biological treatment, the remained organic matters are turned into inorganic molecules via chemical, biochemical methods or physical methods of high purifying degree, which can improve the level of outlet water, water quality and be favorable for the recycling. Via the treatment of this system, in the original water, SS is about 150 mg/l, COD_{CR} (chemical oxygen demand) is about 350 mg/l, BOD₅ (biochemical oxygen demand ) is about 150 mg/l and colon bacillus is about 150×10⁶/l while after treatment, SS is below 10 mg/l, COD_{CR} is below 30 mg/l, BOD₅ is below 10 mg/l and colon bacillus is below 3/l.

### BRIEF DESCRIPTION OF THE DRAWINGS

FIG. 1 is a structural scheme of a system according to an embodiment of the present invention.

FIG. 2 is a structural scheme of an advanced oxidation device in this system.

### DETAILED DESCRIPTION OF THE PREFERRED EMBODIMENTS

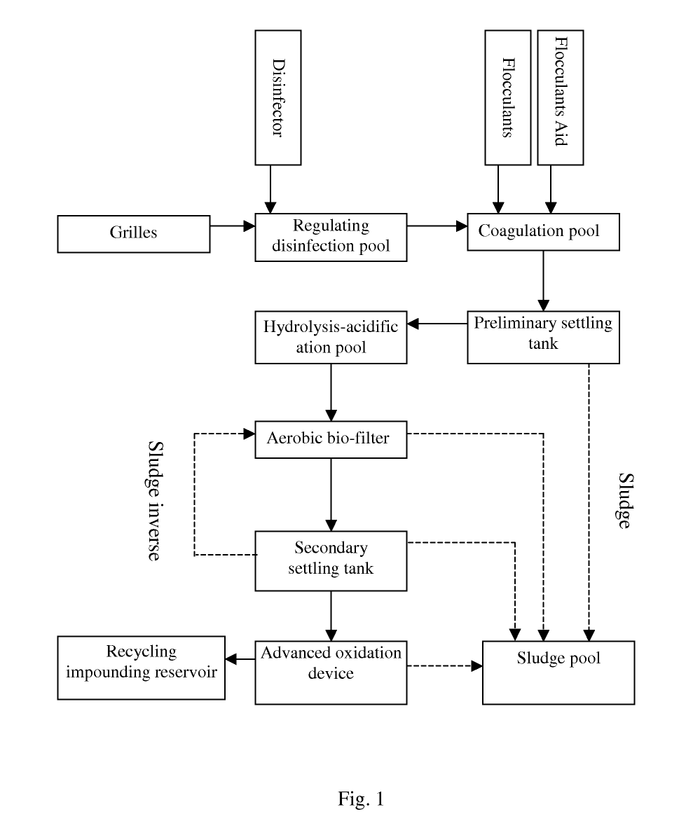

With reference to FIG. 1, the treatment devices of this invention are grilles, a regulating disinfection pool, a coagulation pool, a preliminary settling tank, a hydrolysis-acidification pool, an aerobic bio-filter, a secondary settling tank, an advanced oxidation device and a recycling impounding reservoir, all of which are connected by pipelines or overflow weirs. Wasted gauze as well as other big materials will be caught when the original water passing the grilles, which can adopt arbitrary forms and be separated by thickness while the thick ones adopt the form of bar and the thin ones adopt gridding. An auto chemical feed machine can be installed on regulating disinfection pool and chlorine disinfector (adopting liquefied chlorine gas or sodium hypochlorite) will be put automatically according to the water amount. The inlet water amount can refer to the water gauge behind the grilles or manual regular chemical feeding can also be employed. In the coagulation pool, there are coagulants and relevant aids, e.g. polyaluminium chloride, and the PH value in water can be regulated via lime or industrial sulphuric acid to improve coagulation effect. In the preliminary settling tank, there are active sludge carriers, which can be macromolecule filling carrier, or inorganic filling carrier or embedding carrier to improve the density of active sludge as well as maintain stability. Strengthening anaerobic biological treatment and hydrolysis-acidification treatment: the organic wastewater will be put into highly efficient hydrolysis-acidification pool containing strengthened microorganisms after biological treatment; the carriers can be macromolecule filling carrier or inorganic filling carrier or embedding carrier and the culture can adopt solid powder agent or block agent or active sludge to domesticate and attach the microorganisms, increase its density, improve the biological load to cut large molecules as well as the biochemical capacity, remove part of COD meanwhile the valent state of nitrogen is changed to apply to be removed later; hydrolysis-acidification ferments bacteria using organisms generate acids, break down complicated large organisms into simple small molecules, then further into volatile acids such as acetic acid and monoprop as well as more simple organism such as ethanol and those cells have many categories, high metabolic capability and high propagation speed, which can greatly improve the speed of later biochemical treatment; in the aerobic bio-filter, there are also active sludge carriers to form biological filter materials and realize the decomposition of remained pollutants in short time, the carriers can be macromolecule filling carrier or inorganic filling carrier or embedding carrier and the culture can adopt solid powder agent or block agent or active sludge to domesticate and attach the microorganisms, increase its density, improve the biological load to cut large molecules as well as the biochemical capacity and realize the complete decomposition of the remained COD, ammonian, suspended solid and other pollutants; the organism strengthening techniques will strengthen the dominant microorganisms of strong specificity and high activeness to be higher than the capacity load of traditional active sludge meanwhile the high density and poisonous wastewater, which can not be treated by traditional biochemical method, is processed, which greatly reduces the treating cost of high density water.

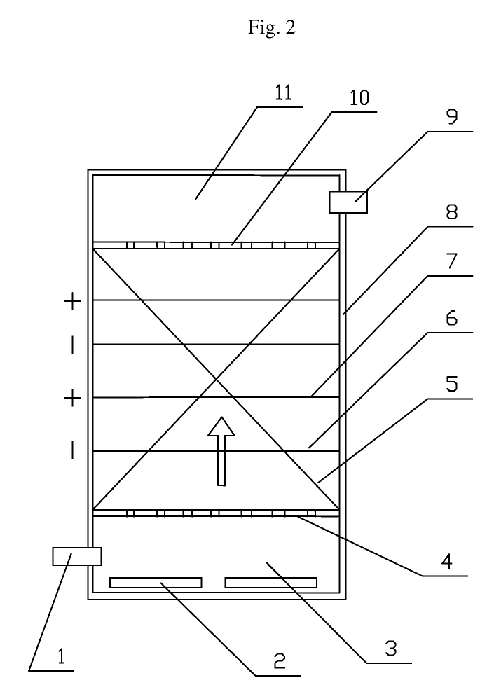

With reference to FIG. 2, in this invention the advanced oxidation device can adopt electric biological oxidation treatment device with a shell 8, there is space in the shell to compose water flow current, there are biological filter materials 5 inside the space as well as several pairs of positive 7 and negative 6 electrodes and the running direction of the electrodes and the one of the water flow current are orthogonal.

The space in the shell is divided into outlet chamber 11, reaction chamber and inlet chamber 3 in turn by two water distributing plates up and down 10, 4. There is an outlet pipe 9 installed in the outlet chamber at the upper part, an inlet pipe 1 installed in the inlet chamber at lower part, an aerator 2 installed at the lower part and biological filter materials 5 in the reaction chamber at the middle. There are transverse positive and negative electrodes, which are distributed up and down as a pair, or left and right as a pair. When various pairs of electrodes distributed vertically or left and right in tridimensional manner, the negative and positive electrodes will be placed transversally and vertically in turns and the negative and positive electrodes insert in the filter materials.

The framework of the filter materials can be organic macromolecule fillings, inorganic fillings or inertia embedding medium such as sodium alginate and PVA.

The filter materials are accumulated or suspended in the reaction chamber and the fill rate of accumulated filter materials in the reaction chamber is 20%-95%.

There is an explosion-proof alarm device installed on the top of the shell.

The positive and negative electrodes can adopt electrodes of catalytic activity made of carbon, iron, stainless steel, porous nickel, palladium, platinum or germanium.

The distance between adjacent negative and positive electrodes is 20-500 mm.

The cross section of the shell can be round or rectangular.

The shell can adopt vertical structure with inlet on the bottom and the water can flow from top to bottom, which is good for reducing water current resistance.

The shell can adopt horizontal structure and the water will flow horizontally inside, which is good for forming a larger length.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A wastewater purifying system in hospitals, comprising:
one or more grilles used to remove solid inclusions;
a regulating disinfection pool used to accumulate original wastewater released from a plurality of sources, to disinfect the original wastewater via chlorination to eliminate organisms including causative organisms, and to regulate a flow rate of subsequent components, wherein an outlet of the grills is connected to an inlet of the regulating disinfection pool;
a coagulation pool used to mix flocculants and flocculent aids to turn suspended substances in the wastewater and part of organic matter into flocs, wherein an outlet of the regulating disinfection pool is connected to an inlet of the coagulation pool;
a preliminary settling tank used to settle settleable matters in wastewater, wherein an outlet of the coagulation pool is connected to an inlet of the preliminary settling tank;
a hydrolysis-acidification pool used to carry out biodegradation under anaerobic conditions to turn large molecules into small molecules;
an aerobic bio-filter used to turn polluted organic molecules into pollution-free inorganic molecules via biological agent in the presence of oxygen, wherein an outlet of the hydrolysis-acidification pool is connected to an inlet of the aerobic bio-filter;
a secondary settling tank used to settle settleable matters generated in the aerobic bio-filter and the original wastewater, wherein an outlet of the aerobic bio-filter is connected to an inlet of the secondary settling tank;
an advanced oxidation device used to oxidize remaining organic matters into inorganic molecules via chemical and biochemical processes or via physical processes, wherein an outlet of the secondary settling tank is connected to an inlet of the advanced oxidation device;
a sludge pool used to collect and primarily process sludge from the preliminary settling tank, the secondary settling tank and the advanced oxidation device;
a recycling impounding reservoir used to collect purified water,
wherein an outlet of the advanced oxidation device is connected to an inlet of the recycling impounding reservoir, and a bottom of the advanced oxidation device is connected to a settling tank via a pump.

2. The system of claim 1, wherein the advanced oxidation device is an electric biological oxidation treatment device which includes a shell, biological materials and a plurality of pairs of electrodes, wherein the biological materials and the plurality of pairs of electrodes are placed in the shell, wherein an extension direction of the electrodes and an direction of water flow in the shell are orthogonal.

3. The system of claim 2, wherein a space in the shell is divided into an outlet chamber, a reaction chamber and an inlet chamber by two water distributing plates.

4. The system of claim 3, wherein the advanced oxidation device further comprises an outlet pipe installed in the outlet chamber, an aerator installed in the inlet chamber and biological filter materials in the reaction chamber.

5. The system of claim 4, wherein the biological filter materials are accumulated or suspended in the reaction chamber.

6. The system of claim 5, wherein a fill rate of accumulated filter materials in the reaction chamber is 20%-95%.

7. The system of claim 2, further comprising one or more negative electrodes and one or more positive electrodes inserted in the filter materials.

8. The system of claim 6, wherein the negative and positive electrodes are distributed vertically or horizontally as one or more pairs.

9. The system of claim 7, wherein the distance between adjacent negative and positive electrodes is 20-500 mm and a cross section of the shell is round or rectangular.

10. The system of claim 9, further comprising an explosion-proof alarm device installed on a top of the shell.

11. The system of claim 10, wherein the shell is a vertical or horizontal structure.

12. The system of claim 4, further comprising one or more negative electrodes and one or more positive electrodes inserted in the filter materials.

13. The system of claim 12, wherein the negative and positive electrodes are distributed vertically or horizontally as one or more pairs.

14. The system of claim 13, wherein the distance between adjacent negative and positive electrodes is 20-500 mm and a cross section of the shell is round or rectangular.

15. The system of claim 14, further comprising an explosion-proof alarm device installed on a top of the shell.

16. The system of claim 15, wherein the shell is a vertical or horizontal structure.

17. The system of claim 5, further comprising one or more negative electrodes and one or more positive electrodes inserted in the filter materials.

18. The system of claim 17, wherein the negative and positive electrodes are distributed vertically or horizontally as one or more pairs.

19. The system of claim 18, wherein the distance between adjacent negative and positive electrodes is 20-500 mm and a cross section of the shell is round or rectangular.

20. The system of claim 19, further comprising an explosion-proof alarm device installed on a top of the shell.
